(19) United States
(12) Patent Application Publication
(10) Pub. No.: US 2013/0031506 A1
(43) Pub. Date: Jan. 31, 2013

(54) HOTEL RESULTS INTERFACE

(71) Applicants: Alejandro Diaz, San Francisco, CA (US); Emmet J. Connolly, Zurich (CH); Stefan H. Pharies, Zurich (CH); Emma Burrows, Zurich (CH); Amar Singh Sagoo, Thalwil (CH); Andrew J. McCarthy, Zurich (CH)

(72) Inventors: Alejandro Diaz, San Francisco, CA (US); Emmet J. Connolly, Zurich (CH); Stefan H. Pharies, Zurich (CH); Emma Burrows, Zurich (CH); Amar Singh Sagoo, Thalwil (CH); Andrew J. McCarthy, Zurich (CH)

(73) Assignee: GOOGLE INC., Mountain View, CA (US)

(21) Appl. No.: 13/557,062

(22) Filed: Jul. 24, 2012

Related U.S. Application Data
(60) Provisional application No. 61/511,474, filed on Jul. 25, 2011.

(51) Int. Cl. G06F 3/048

(52) U.S. Cl. 715/781

(57) ABSTRACT

Methods, systems, and apparatus, including computer programs encoded on a computer storage medium, for information retrieval. In one aspect, a method includes receiving an input specifying one or more hotel search parameters; obtaining hotel search results responsive to the input; presenting the hotel search results in a first region of a hotel search results interface; receiving a user selected hotel from among the hotel search results; and presenting the user selected hotel in a second region of the hotel search results interface.

### CROSS-REFERENCE TO RELATED APPLICATIONS

This application claims the benefit under 35 U.S.C. §119(e) of U.S. Provisional Application Ser. No. 61/511,474, filed on Jul. 25, 2011 entitled “HOTEL RESULTS INTERFACE,” the entirety of which is hereby incorporated by reference.

### BACKGROUND

This specification relates to information retrieval.

Users can use various web sites to plan travel including reserving hotel stays. Conventionally, a user navigates to either a web site corresponding to a particular entity (e.g., a site belonging to a specific hotel or hotel brand) or to a web based travel booking site that provides access to several different hotels. Once the user has identified an itinerary for travel (e.g., a particular hotel for a particular date range), they can typically purchase the itinerary directly through the web site.

### SUMMARY

This specification describes technologies relating to information retrieval.

A user can search for hotels responsive to one or more hotel search parameters including, for example, a location and travel dates. The presented hotel search results can be presented in an interface in various forms. For example, a listing of results can be presented, an array of results can be presented, or the results can be presented relative to a map.

In some implementations, users select individual hotel results and add them to a separate shortlist. The user can then compare the selected individual hotels separate from the overall listing of results.

The listing of results can include an indication of the relative price for each hotel. The relative price indicates how the price for the hotel on the selected travel dates compares to a historic price for the hotel (e.g., an average price over a specified period of time).

In some implementations, a user can expand individual hotel results in the hotel results listing. The expanded hotel result can be presented inline with the hotel listings. The expanded hotel result can provide additional information about the hotel without viewing the hotel information in a separate interface.

A user can also select a particular hotel result from the hotel results listing. In response to the selection a separate hotel card can be displayed. The hotel card can be displayed in a separate interface or as an overlay to the results interface. The hotel card can be associated with navigation elements allowing the user to switch to other hotel cards corresponding to hotel results preceding or following the hotel result in the hotel results listing without returning to the hotel results listing.

In some implementations, the hotel results are presented in an array including representative images for respective hotel results. A user can add filtering criteria including inputting a text phrase indicating some feature of the hotel results. A portion of the review can be presented as an overlay to corresponding hotel results in the array. For example, a text segment (e.g., a specified number of words, a sentence, or a number of words plus or minus some point) from the review can be used. The text segment can be relative to a phrase associated with the input text phrase, for example, matching one or more words. The text segment can be a snippet of the review.

In general, one aspect of the subject matter described in this specification can be embodied in methods that include the actions of receiving an input specifying one or more hotel search parameters; obtaining hotel search results responsive to the input; and presenting a hotel search results interface, the hotel search results interface including a first region displaying one or more hotel listings for the hotel search results and a second region, where the second region is configured to present one or more user selected hotels from the one or more hotel listings. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Each of the one or more hotel listings includes an indicator of the relative price of a particular hotel compared to historic prices for that hotel. The method further includes receiving user input selecting a hotel from the one or more hotel listing; and adding the hotel to the second region. The hotel search results interface further including a third region including one or more filtering parameters, where the filtering parameters include filtering according to relative price. A hotel added to the second region persists through additional inputs specifying one or more hotel search parameters. The method further includes receiving a user input selecting a hotel from the one or more hotel listings; and expanding an entry for the selected hotel inline within the one or more hotel listings, wherein the expanded entry displays additional information about the selected hotel.

In general, one aspect of the subject matter described in this specification can be embodied in methods that include the actions of receiving an input specifying one or more hotel search parameters; obtaining hotel search results responsive to the input; and presenting a hotel search results interface, the hotel search results interface including displaying a plurality of hotel listings corresponding to the hotel search results; receiving an input selecting a hotel listing from the plurality of hotel listings; and presenting a hotel card displaying additional hotel information, wherein the hotel card includes one or more navigation buttons for switching to a next or a previous hotel card corresponding to a respective listing from the plurality of hotel listings. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The presenting the hotel card includes generating an overlay to the hotel search results interface. The hotel card includes one or more of photos, reviews, pricing, or purchasing options for the hotel.

In general, one aspect of the subject matter described in this specification can be embodied in methods that include the actions of receiving an input specifying one or more hotel search parameters; receiving hotel search results responsive to the input; and presenting a hotel search results interface, the hotel search results interface including displaying a plurality of hotel listings corresponding to the hotel search results, the plurality of hotel listings being organized in a plurality of groups, each group including one or more of the plurality of hotel listings satisfying a particular criteria for the group. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The criteria is rating level. The hotel search results are presented as an array of individual hotel entries. The method further includes displaying a hotel card in response to a user selection of a particular hotel listing of the plurality of hotel listings.

In general, one aspect of the subject matter described in this specification can be embodied in methods that include the actions of receiving an input specifying one or more hotel search parameters; receiving hotel search results responsive to the input; and presenting a hotel search results interface, the hotel search results interface including displaying a plurality of hotel listings corresponding to the hotel search results; receiving an input of a text segment; and presenting a text portion of a review as an overlay to each of one or more of the plurality of hotel listings, where each review is identified based on the input text segment. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The filtering criteria is a text phrase. The text phrase is used to determine one or more associated reviews for one or more hotels of the plurality of hotel listings and wherein the text portion for a particular hotel listing is generated from a corresponding review. The individual listings of the plurality of hotel listings are images representing the respective hotels and the overlay is over the image.

In general, one aspect of the subject matter described in this specification can be embodied in methods that include the actions of receiving an input specifying one or more hotel search parameters; receiving hotel search results responsive to the input; and presenting a hotel search results interface, the hotel search results interface including displaying a plurality of hotel listings corresponding to the hotel search results; and presenting a hotel rating as an overlay to each of one or more of the plurality of hotel listings. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The plurality of hotel listings are grouped according to the presented hotel rating. The hotel rating is an average reviewer rating. The hotel listings are grouped by hotel rating and are further sorted according to one or more other sorting criteria.

In general, one aspect of the subject matter described in this specification can be embodied in methods that include the actions of receiving an input specifying one or more hotel search parameters; receiving hotel search results responsive to the input; and presenting a hotel search results interface, the hotel search results interface including displaying a map interface including a polygon demarcating a particular region of the map wherein the polygon limits the presented hotel search results to those within the boundaries of the polygon. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Each hotel search result includes an indicator showing a location on the map for each respective hotel search result. The method further includes displaying a gradient overlay to the map such that particular geographic areas identified as having a particular characteristic are displayed brighter than other geographic areas of the map.

Particular embodiments of the subject matter described in this specification can be implemented so as to realize one or more of the following advantages. Hotel search results can be presented in a format that allows a user to quickly identify hotels of interest. Users can identify hotels of interest and place them in a separate portion of the results interface for comparison and/or to keep track of particular hotels. Hotel results can be filtered according to particular parameters to refine the results and to augment the display. For example, results can be sorted and reorganized according to different criteria. Additionally, overlays can be presented on the search results corresponding to particular features of the hotels. This allows users to quickly identify hotels associated with those features. Individual hotels can be presented with additional information and the user can quickly navigate between hotels without returning to an overall hotel results listing.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flow diagram of an example process for presenting hotel search results.

FIG. 2 is an example hotel results interface.

FIG. 3 is an example hotel results interface including an expanded hotel result.

FIG. 4 is an example hotel results interface including a shortlist hotel.

FIG. 5 is an example interface including a hotel result card.

FIG. 6 is an example hotel results interface including a results array.

FIG. 7 is an example hotel results map interface.

FIG. 8 is an example hotel results interface including a hotel result card.

FIG. 9 is an example hotel results interface including a results array ordered by rating class.

FIG. 10 is an example hotel results interface including a hotel result card overlay.

FIG. 11 is an example hotel results interface including a results array.

FIG. 12 is an example hotel results interface including review text.

FIG. 13 is an example hotel results interface including rating class.

FIG. 14 is an example hotel results map interface including a tourist spotlight.

FIG. 15 is a flow diagram of an example process for presenting hotel search results.

FIG. 16 is an example hotel results interface including an expanded hotel result.

FIG. 17 is an example hotel results interface including an expanded hotel result including an image.

FIG. 18 is an example hotel results interface including an expanded hotel result including a street view.

FIG. 19 is an example hotel results interface including an expanded hotel result including a video.

FIG. 20 is an example hotel results interface including an expanded hotel result.

FIG. 21 is an example hotel results interface including an expanded hotel result.

Like reference numbers and designations in the various drawings indicate like elements.

### DETAILED DESCRIPTION

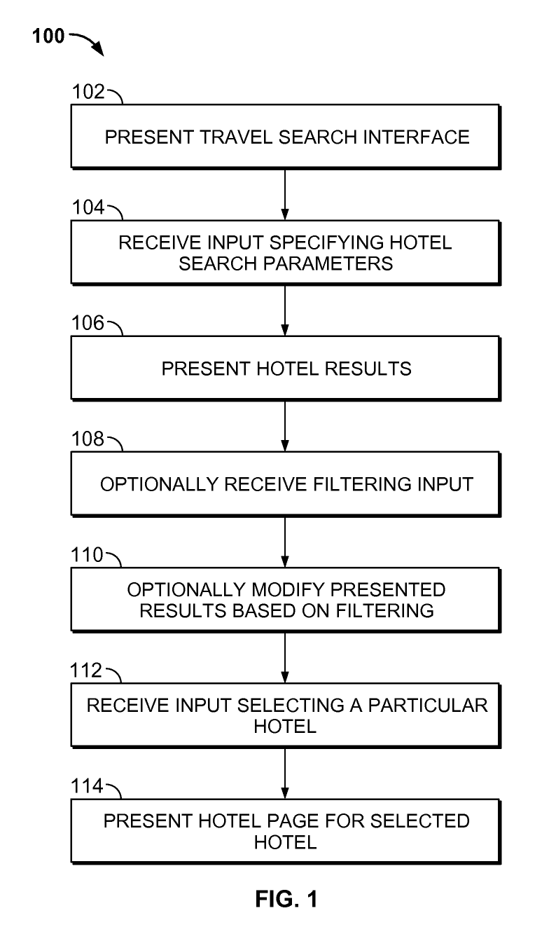

FIG. 1 is a flow diagram of an example process 100 for presenting hotel search results. For convenience, the process 100 will be described with respect to a system including one or more computing devices that performs the process 100.

The system presents a travel search interface (102). The travel search interface can be part of a separate travel site or initiated through a particular search interface. The travel search interface can be accessed directly by the user, for example, by accessing a travel search web page. Alternatively, a user can enter a query “hotels” or “hotels San Francisco” in a search interface and be directed to the travel search interface. In another example, the user can provide a query to a map search interface that specifies a request for hotels in a particular geographic location (e.g., “hotels san Francisco” or “hotels 94107”). In some implementations, the travel search interface encompasses various travel types including flights and hotels. In some other implementations, an interface for a specific travel type is provided, for example, a hotel search interface.

The presented travel search interface can include one or more search parameters particular to the travel type. For example, for a hotel search interface, the search parameters can include a location and one or more travel dates. The location can be a particular geographic region, for example, a particular neighborhood, city, region, or country. The travel dates can include both a check-in and check-out date or a check-in date and a number of nights. Other parameters can also be presented by the travel search interface, for example, indicating a type of room (e.g., king, double), smoking preferences, or hotel class or reviewer rating.

The system receives input specifying hotel search parameters (104). For example, each of the hotel search parameters can have text fields, check boxes, drop down menus, or a combination, for receiving user input selecting particular parameter values. In some implementations, a calendar is provided for selecting travel dates, either as a range or as specified arrival and departure dates. The calendar can be part of the travel search interface or can be presented (e.g., as a popup or overlay) in response to user input. In some implementations, not all hotel search parameters need be specified in order to initiate a search. For example, only a location may be required to identify hotels. However, both a location and date may be required to present results including pricing information. Additionally, some search parameters may have default values that are used absent user modification. In some implementations, the hotel parameters include a mechanism allowing the user to specify one or more particular hotels (e.g., “Hotel ABC, San Francisco”). Additionally, in some implementations, hotels are suggested based on some portion of input provided by the user. For example, a partial name can be used to suggest matching hotels.

The system presents hotel search results (106). Hotel results can be determined, for example, by a search performed on a database of hotels or through submission of the search parameters to a search system. The system can provide a results interface that displays one or more hotel search results. The hotel search results can be presented in various forms, as described in greater detail below. For example, the hotel search results can be an ordered listing of hotels, an array of images, a map, or other organizational structure. In some implementations, the user can switch between display types.

The hotel search results can be groups according to particular criteria. In some implementations, the hotel search results are presented with a map interface that identifies the locations of the respective hotel search results. The hotel search results can be presented directly on the map or in a separate region of the results interface with corresponding indicators on the map. The results interface can include other elements, for example, filtering parameters and sorting parameters for filtering or organizing, respectively, the hotel search results.

The system optionally receives filtering input (108). The filtering input can specify one or more parameter values or thresholds. For example, the user can select a specific, minimum, or range of hotel ratings (e.g., 4 star only or greater than 3 stars). Another parameter can allow the user to select a price minimum, maximum, or range. Other example parameters can include parameters to filter the hotel results based on user ratings for the hotels or specific hotel amenities (e.g., pool, spa, restaurant).

In some implementations, the user can filter hotel results based on a relative price of the hotel. The relative price is an indicator of how the price for the hotel on the specified travel dates relates to the historical price for the hotel (e.g., over a specified time period). Thus, a filtering can be used to limit search result to those, for example, that are equal to or less than the typical price for the hotel (e.g., therefore filtering out those results of hotels having prices for the specified dates that are greater than typical for that hotel). In some implementations, the relative price can be provided as a percentage value, for example, a percentage more or less relative to an average price. In some other implementations, the relative price can be indicated by a graphic or color code rather than a number value. For example, a green graphic can indicate the price is better than average (a good deal) while a red graphic can indicate the price is worse than average (a bad deal). A threshold percentage difference from average can be used to trigger the indicator. For example, if price is 20% or more than average price than indicated with red graphic.

In some implementations, popup or tooltip text can indicate additional information about the relative price. For example, a percentage or graphic indicator can be displayed. When the user hovers over the indicator, text can explain the relative price, for example, “This hotel is 30% cheaper than its typical price over the last year.”

In some implementations, the user can select particular hotels as potential hotels for reserving. A shortlist of user selected hotels can be presented in a separate region of the hotel results interface. The user can then compare the hotels in the shortlist prior to making a purchasing decision.

The system optionally modifies presented hotel results based on the filtering input (110). In particular, the system can remove those hotel results from being presented that do not satisfy the filtered criteria.

The system receiving input selecting a particular hotel from the presented hotel search results (112). For example, the user can use a cursor or touch input (e.g., using a touch mobile device or table device) to select a particular hotel listing from the hotel search results (e.g., by clicking on the particular result). Alternatively, or in addition, one or more keyboard shortcuts can be used to navigate the presented search results (e.g., to move through the listing or to select a particular result for viewing or shortlisting). In some implementations, an initial selection presents an expanded listing that provides additional hotel information. The user can then make another selection to view a separate hotel details page for the selected hotel. In some implementations, the user can initiate booking directly from the expanded listing.

The system presents a hotel page for the selected hotel (114). The hotel page can be a separate user interface providing details about the selected hotel. In some other implementations, the hotel page is an overlay presented on top of the displayed hotel search results. The hotel page can include, for example, images of the hotel, a map location, reviews of the hotel, address information, and pricing information.

In some implementations, a user selects a booking option in the hotel page or from hotel results listings. For example, a user can be directed to the hotel directly or to one or more third party booking locations (e.g., partner booking web sites). For example, a listing of different third party booking locations can be presented along with the corresponding hotel price for each. Alternatively, the user can be provided with information for contacting a booking provider.

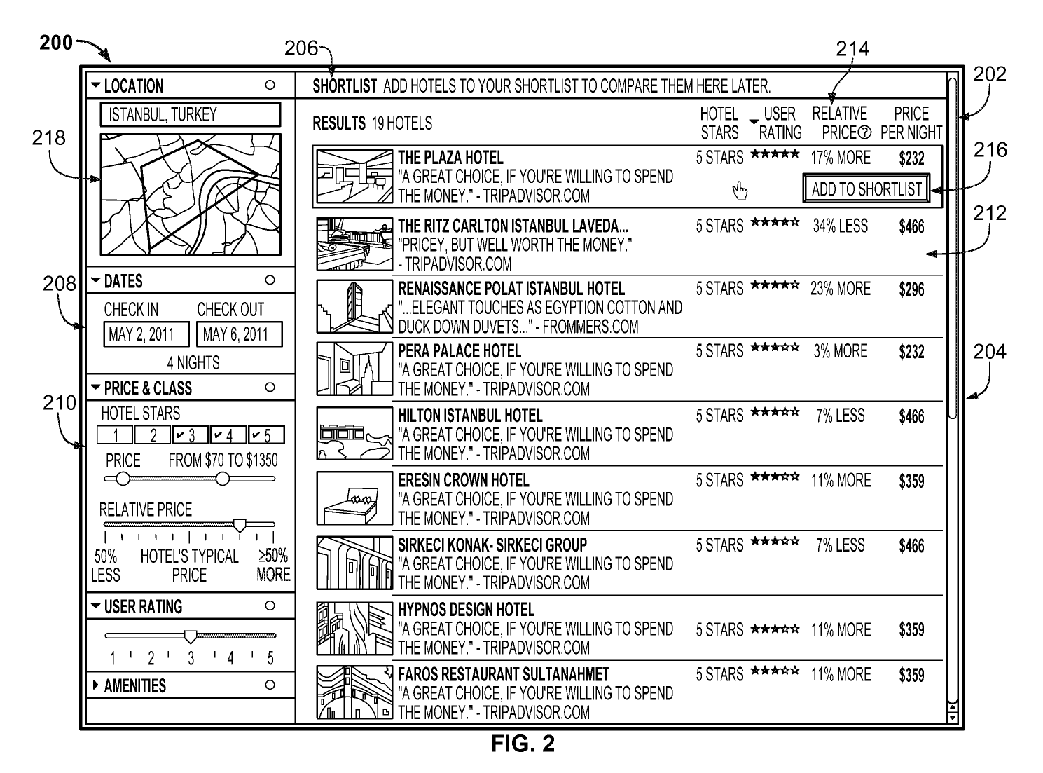

FIG. 2 is an example hotel results interface 200. The hotel results interface 200 includes a first region 202 displaying a listing of hotel results 204, a second region 206 for displaying a hotel shortlist, a map region 218, dates 208, and filtering parameters 210.

The listing of hotel results 204 includes a number of separate listings for hotels responsive to a search. For example, the user can input a search for hotels in Istanbul, Turkey for the dates of May 2 to May 6 (as shown in dates 208) within a search interface. The resulting matching hotels are displayed in the listing of hotel results 204. The listing can include additional hotel results not shown, but accessible though user interaction with the hotel results interface 200 (e.g., using scroll bar or links to additional pages of results).

Each of the individual listings includes summary information about the particular hotel. For example, hotel result 212 includes the hotel name, a representative image, a hotel ratting, a user rating, a relative price, and an average price per night. In some alternative implementations, the total price for the stay is shown rather than per night. The hotel result 212 also includes an excerpt (e.g., a snippet) of a review and an option to add the hotel result to a shortlist 216. Adding the hotel result to the shortlist adds the particular hotel to the second region 206. The user can then assemble one or more hotels from the listing of hotel results 204 within the second region 206. In some alternative implementations, a user can drag and drop hotel results to the second region 206 to add them to the shortlist. Additionally, the user can order the hotels within the shortlist.

The listing of hotel results 204 also includes a number of sorting headers 214 that the user can select in order to modify the ordering of the hotels included in the listing of hotel results 204. The sorting headers 214 include the hotel rating, the user rating, the relative price, and the average price per night. As shown in FIG. 2, the user rating is selected as a sorting criterion where the hotels are ordered from highest user rating to lowest. In some implementations, the user can reverse the sorting order (e.g., from lowest to highest rating), for example, by a second selection of the selected sorting criterion. In some implementations, different criteria are used to determine the ordering of the hotel results for a particular sorting.

The map region 218 can display the geographic locations for one or more of the hotels displayed in the listing of hotel results 204. A bounding polygon can define a region in which all the hotels are located. In some implementations, selection of the map allows the user to view additional details about the location or to modify the selected area in which hotel results are located (e.g., as bound by the polygon).

The dates 208 are editable so that the user can modify the dates for the hotel stay. For example, the user can modify the check in date, the check out date, or both.

The filtering parameters 210 include a number of separate filtering parameters that can be used to refine the presented results. The filtering parameters 210 shown include filters for price, hotel class, user rating, and amenities. Selection of a particular type of filtering parameter can results in an expansion displaying one or more filtering options for that filtering parameter. A subsequent selection of the filtering parameter can collapse the filtering options. For example, the user rating parameter is shown as expanded while the amenities parameter is shown as collapsed.

The filtering parameters 210 include a hotel rating. For example, the user can select a minimum or specific hotel rating (e.g., 4 star only or greater than 3 stars). The filtering parameters 210 also include a price filter can allow the user to select a price minimum, maximum, or range of prices. The filtering parameters 210 include parameters to filter the hotel results based on user ratings for the hotels or specific hotel amenities (e.g., pool, spa, restaurant).

The filtering parameters 210 also include a relative price of the hotel. The relative price is an indicator of how the price for the hotel on the specified travel dates relates to the historical price for the hotel (e.g., over a specified time period). For example, a slider can be presented that allows the user to define upper and lower bounds for the relative price. Thus, a filtering can be used to limit search result to those, for example, that are equal to or less than the typical price for the hotel (e.g., therefore filtering out those results of hotels having prices for the specified dates that are greater than typical for that hotel).

While the example listing of hotel results shown in FIG. 2 includes prices, hotel ratings, etc. However, other hotel results interfaces can present listings of hotel results that have some, all, or none of these features. For example, prices may not be shown and/or hotel ratings may not be shown.

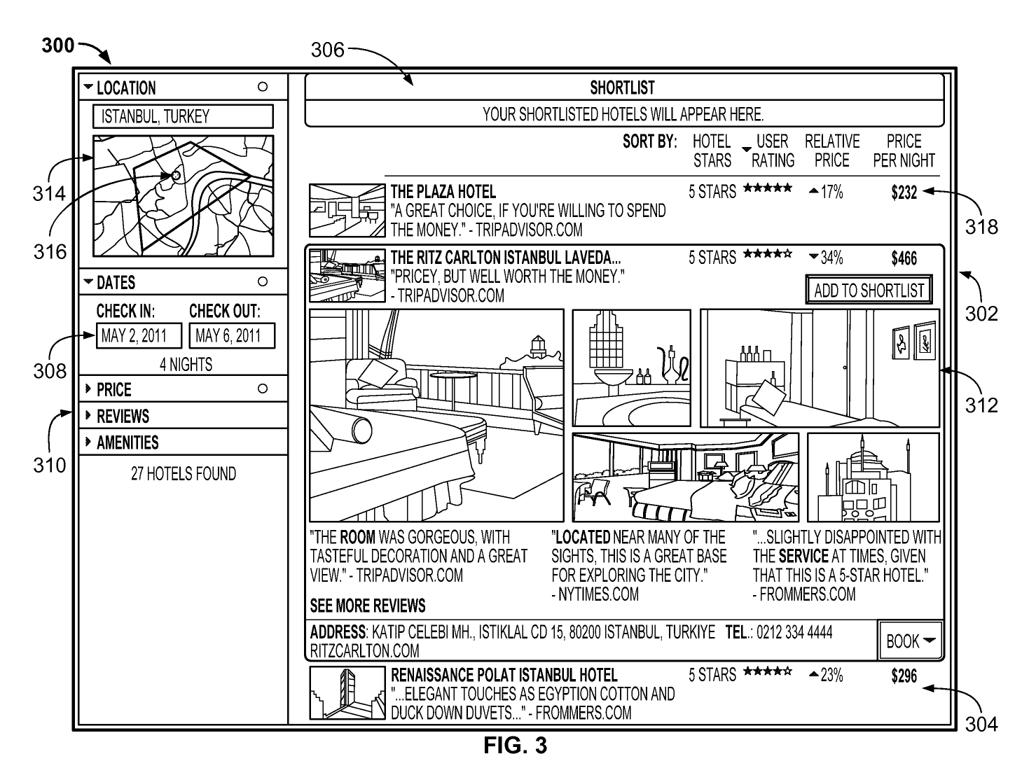

FIG. 3 is an example hotel results interface 300 including an expanded hotel result. Similar to the hotel results interface 200, the hotel results interface 300 includes a first region 302 displaying a listing of hotel results 304, a second region 306 for displaying a hotel shortlist, a map region 314, dates 308, and filtering parameters 310.

The listing of hotel results 304 includes a number of separate listings for hotels responsive to a search. Additionally, one of the listings is an expanded listing 312. The expanded listing 312 can be, for example, the result of a user input to, or selection of, a hotel in the listing of hotel results. For example, selection of hotel 212 of FIG. 2. The expanded listing 312 provide additional information about the particular hotel compared with a non-expanded listing, for example, hotel listing 318. In some implementations, hotels that have been selected by the user are visually indicated, e.g., by a color or border. This can apply to those selected to view and expanded listing or only those that have been separately displayed, e.g., using a hotel card, as discussed below.

The expanded listing 312 provides additional hotel information inline within the listing of hotel search results 304. Thus, for example, other results below the expanded listing 312 are shifted down in the listing of hotel results 304 in order to accommodate the expanded listing 312. The expanded listing 312 includes a group of images, review text or text portions (e.g., snippets), address and contact information, as well as a booking user interface element (e.g., a button). The group of images can be arranged in a collage of images having different sizes. In particular, the images can be selected to provide a quick overview of different aspects of the hotel. For example, an image of a room, the front of the hotel, and a pool. In other implementations, different numbers or layouts of images are presented in the expanded listing. Also, in some implementations, instead of, or in addition to, review text, content provided by the hotel is presented, for example, a summary or overview of the hotel. Additionally, as shown in the hotel results interface 300, the expanded listing 312 also includes a user interface element (e.g., a button) to add the hotel to the second region 306 as part of the hotel shortlist.

The map region 314 displays a geographic region including one or more of the hotels in the listing of hotel search results 304. Additionally, as shown in the map region 314, an indicator 316 shows the location of the selected hotel, e.g., the hotel corresponding to the expanded listing 312.

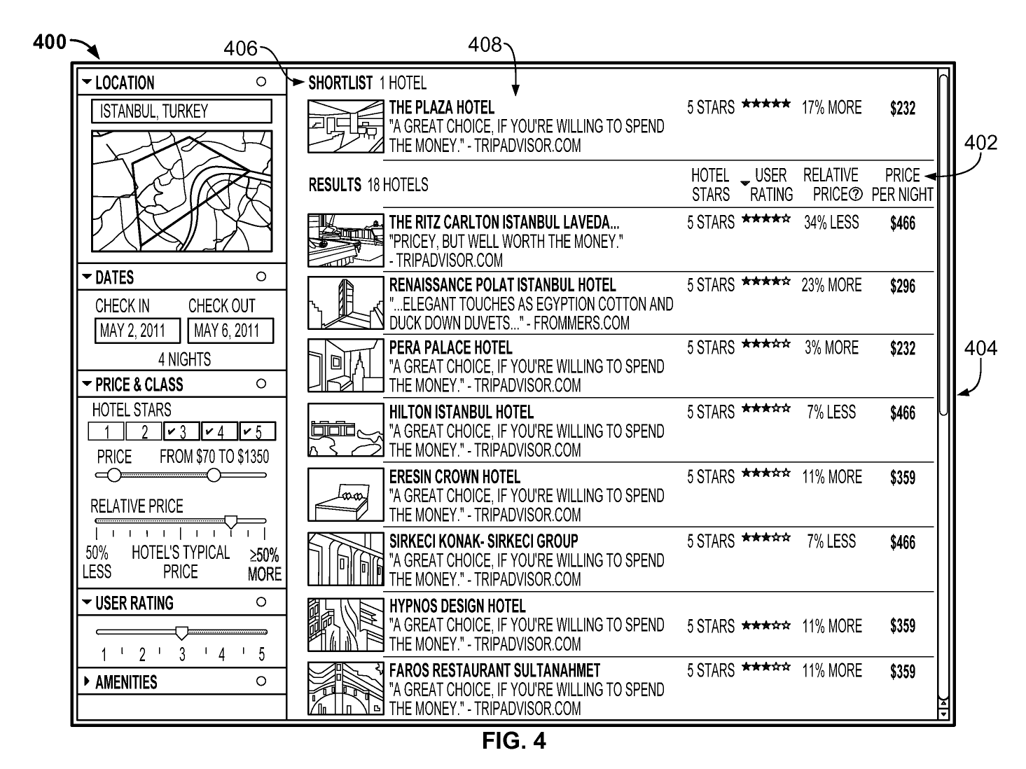

FIG. 4 is an example hotel results interface 400 including a hotel added to a shortlist. The hotel results interface 400 includes a first region 402 displaying a listing of hotel results 404, and a second region 406 displaying a hotel shortlist. In particular, the second region 406 includes hotel listing 408 added to the hotel shortlist.

The listing of hotel results 404 includes a number of separate listings for hotels e.g., those responsive to a particular search. The hotel listing 408 can represent a hotel listing of the listing of hotel results 404 that has been moved from the listing of hotel results 404 to the hotel shortlist. The hotel shortlist allows a user to collect specified hotel listings within the second region 406. This allows the user to group particular hotel listings for further consideration in one place.

In some implementations, the hotels in the shortlist persist across multiple searches. For example, a user can search for hotels in the Napa Valley town of St. Helena and add a hotel to the shortlist and then perform a second search for hotels in the Napa Valley town of Yountville and add a hotel to the shortlist. The user can then compare the two shortlisted hotels from these different searches. Alternatively, the user can modify filtering parameters without losing shortlisted hotels.

In some other implementations, the hotels in the shortlist are used to identify one or more hotel suggestions. For example, if the user has shortlisted hotels A and B, this may indicate that a user interest in similar hotel C. This suggested hotel can be promoted in the search results listing. Alternatively, in some other implementations, once a user has indicated a preference for a few hotels by adding them to the shortlist, an advertiser may provide a special promotion to further encourage the user to make a reservation.

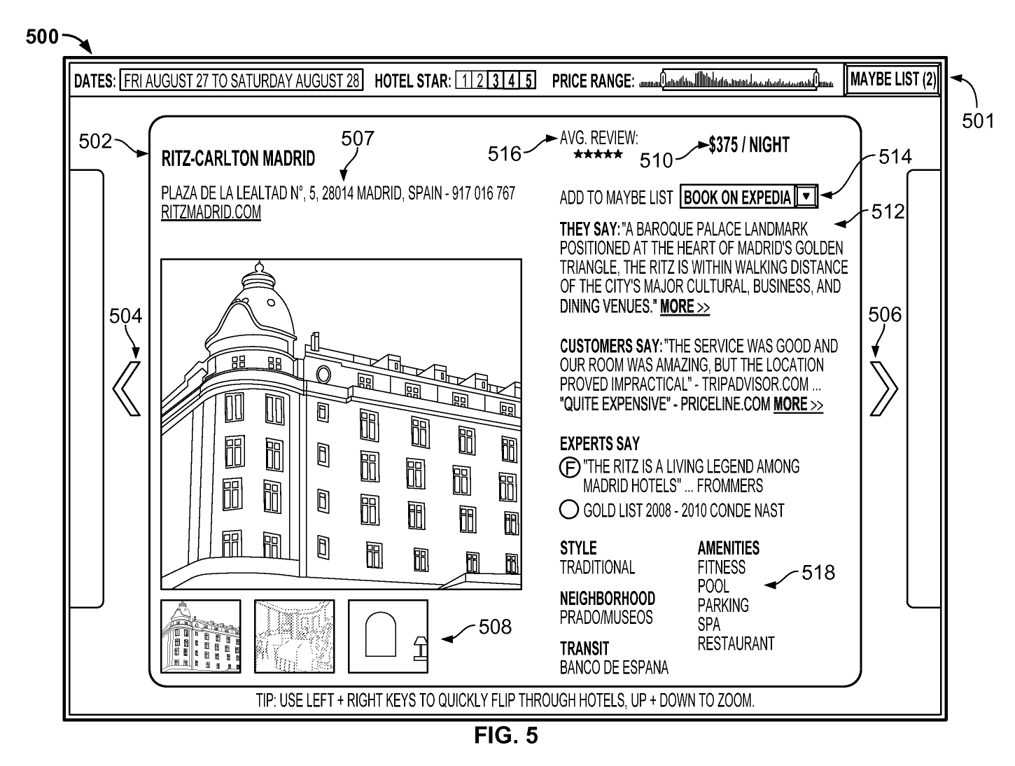

FIG. 5 is an example interface 500 including a hotel result card 502. The hotel result card 502 can be presented, for example, in response to a user input or selection within a listing of hotel search results. The hotel results card 502 provides information about the particular selected hotel as well as navigation elements allowing the user to directly go to a corresponding hotel result card for a preceding or subsequent hotel result in a listing of hotel search results (e.g., listing of hotel results 404). The interface 500 also includes general hotel information 501. The general hotel information 501 includes particular hotel parameters common to each hotel results card, for example, the dates of travel, hotel rating filter, and a hotel price range. In some implementations, the hotel price range is user constrainable. Additionally, the hotel price range can be set relative to a histogram representation showing hotel results broken up into a number of pricing bins.

The navigation elements can include back arrow 504 and forward arrow 506. When a particular navigation element is selected by a user, the next sequential hotel card in the indicated direction is presented. For example, if a user selects a fifth hotel listing in a listing of hotel results (e.g., the listing of hotel results 204), the corresponding hotel result card is presented. Selecting the back arrow results in presentation of the hotel result card for the fourth hotel listing in the listing of hotel results. Selecting the forward arrow results in presentation of the hotel result card for the sixth hotel listing in the listing of hotel results. Thus, the user can quickly flip between hotel cards representing hotels without returning to a listing of hotel results (e.g., listing of hotel results 404). In some alternative implementations, the navigation arrows present a next hotel card based on geographic distance of the hotels from the previous hotel.

The hotel result card 502 includes hotel information 507, hotel images 508, pricing 510, reviews 512, booking options 514, average review indicator 516, and other hotel information 518.

The hotel information 507 includes the hotel name and contact information (e.g., address, phone number, web site). The hotel images 508 includes one or more images of the hotel. In particular, one image is depicted along with smaller images, for example, thumbnails or other reduced/scaled representations. The user can select the smaller images in order to display a larger version of the image.

The pricing 510 indicates the price per night of the hotel for the given dates identified in the general hotel information 501. The reviews 512 display excerpts, e.g., snippets, of reviews that can each be expanded or retrieved in response to user input. The reviews can include individual reviews as well as professional reviews. The source of each review can be indicated, for example, by text including a link to the source. The average review indicator 516 provides a graphical representation of the average review assessment, for example, as a star rating.

The booking options 514 allow the user to select from one or more booking providers in order to reserve the hotel for the selected dates. The booking providers can include both third party travel providers as well as the hotel directly.

The other hotel information 518 includes other details about the hotel, for example, particular amenities available at the hotel and category information about the hotel.

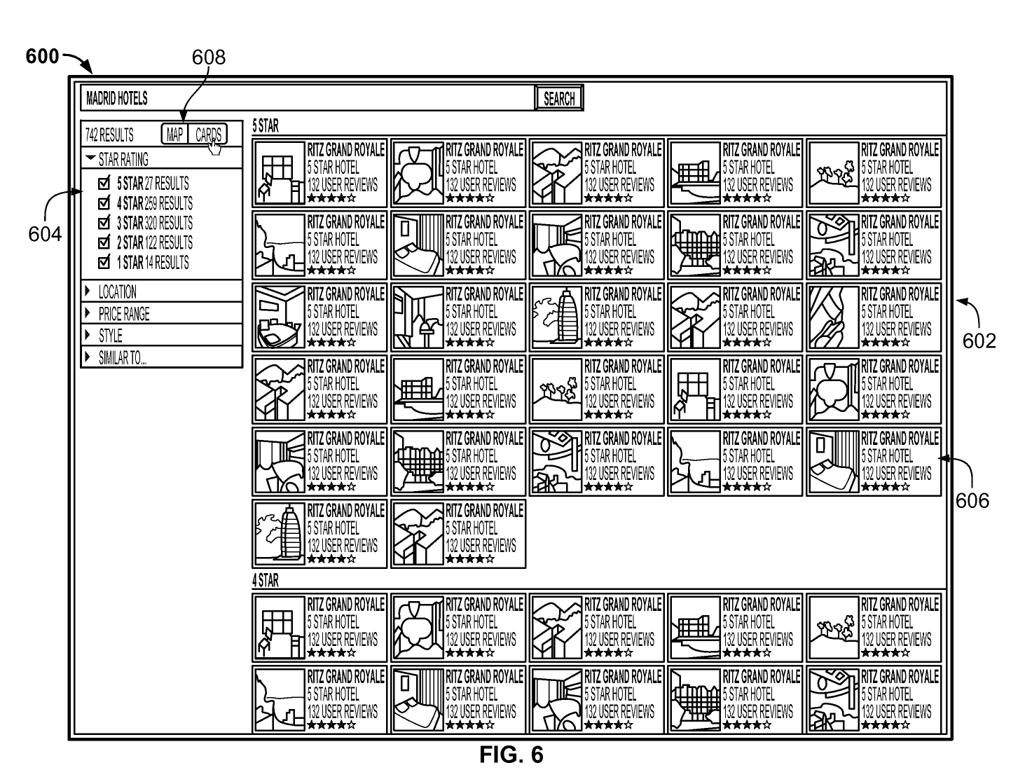

FIG. 6 is an example hotel results interface 600 including a results array 602. The results array 602 provides a collection of hotel results as an array of individual hotel results. The array of individual hotel results can include, for example, an m×n array where each entry in the array is a particular hotel result. In the example results array 602, the hotel results are grouped by hotel rating, thus all five star hotels from the hotel results are grouped together followed by all four star hotels, and so on.

In some other implementations, hotel results can be grouped according to other criteria. For example, the hotel results can be grouped according to particular price ranges. In another example, the hotel results can be grouped according to user ratings. Similarly, the hotel results can be grouped according to location relative to some point (e.g., distance from city center).

The hotel results interface 600 also includes filtering parameters 604. The filtering parameters 604 allow a user to modify the presented hotel results based on specifying values for one or more of the filtering parameters 604.

The results array 602 allows for more hotel result to be displayed than a listing, e.g., listing of hotel results 204, within a region of the same size. However, the results array 602 can provide less information do to a more compact sizing. An example hotel results 606 of the results array includes a hotel name, a representative image, a hotel rating, and an indicator of the number of individual user reviews for the hotel.

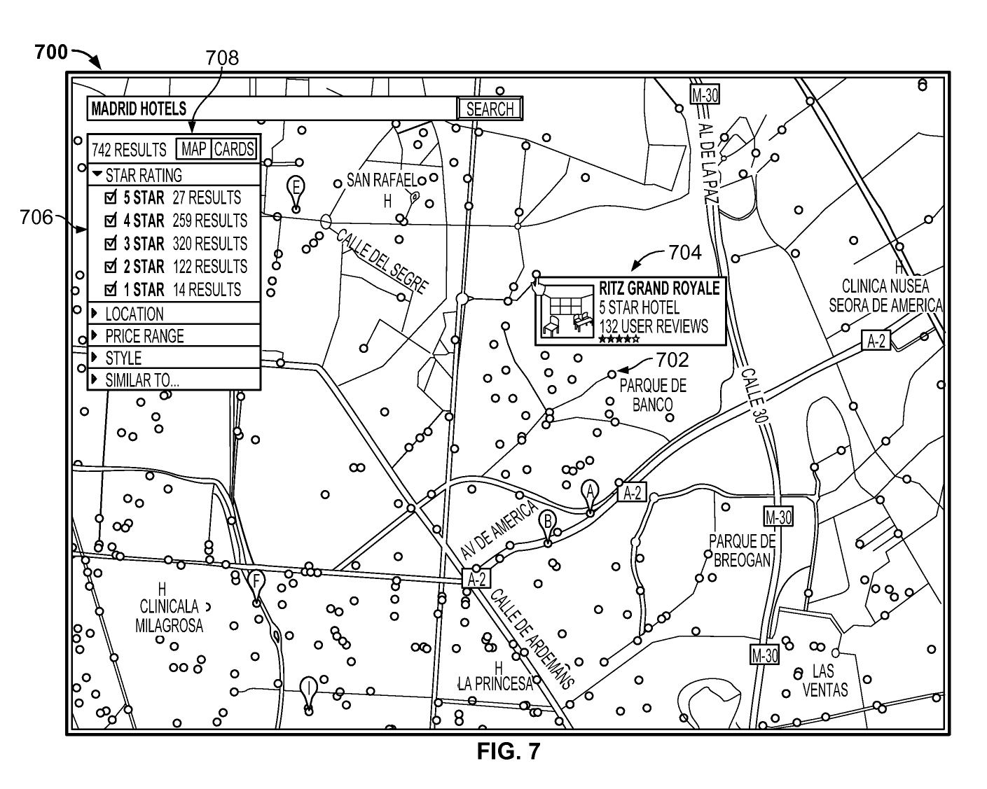

The hotel results interface 600 also includes a view format selection 608. The view format selection 608 allows the user to choose between viewing the hotel results as the results array 602 or as a map interface. An example map interface is shown in FIG. 7.

FIG. 7 is an example hotel results map interface 700. The hotel results map interface 700 shows a geographic region associated with a hotel search, e.g., a particular city or region of a city. In some implementations, the map display is adjustable. For example, a user can pan in different directions or change a zoom level. This can result in the displayed hotel results being updated accordingly. Additionally, visual indicators of hotel results are displayed within the geographic region, e.g., as dots or flags. For example, visual indicator 702 is an example indicator representing a particular hotel result. When selected, each visual indicator provides additional information about the hotel at that location without leaving the current map interface. For example, a hotel entry 704 can be displayed on the map. The hotel entry 704 can include additional hotel information including the hotel name, a representative image, a hotel rating, and a number of reviews for the hotel. Selection of a particular displayed hotel entry 704 can results in display of additional information about the hotel, for example, using a separate interface or overlay.

The hotel results map interface 700 also includes filtering parameters 706. The filtering parameters 706 allow a user to modify the presented hotel results based on specifying values for one or more of the filtering parameters 706.

The hotel results map interface 700 also includes a view format selection 708. The view format selection 708 allows the user to choose between viewing the hotel results as the results array, e.g., results array 602, or as the results map interface 700.

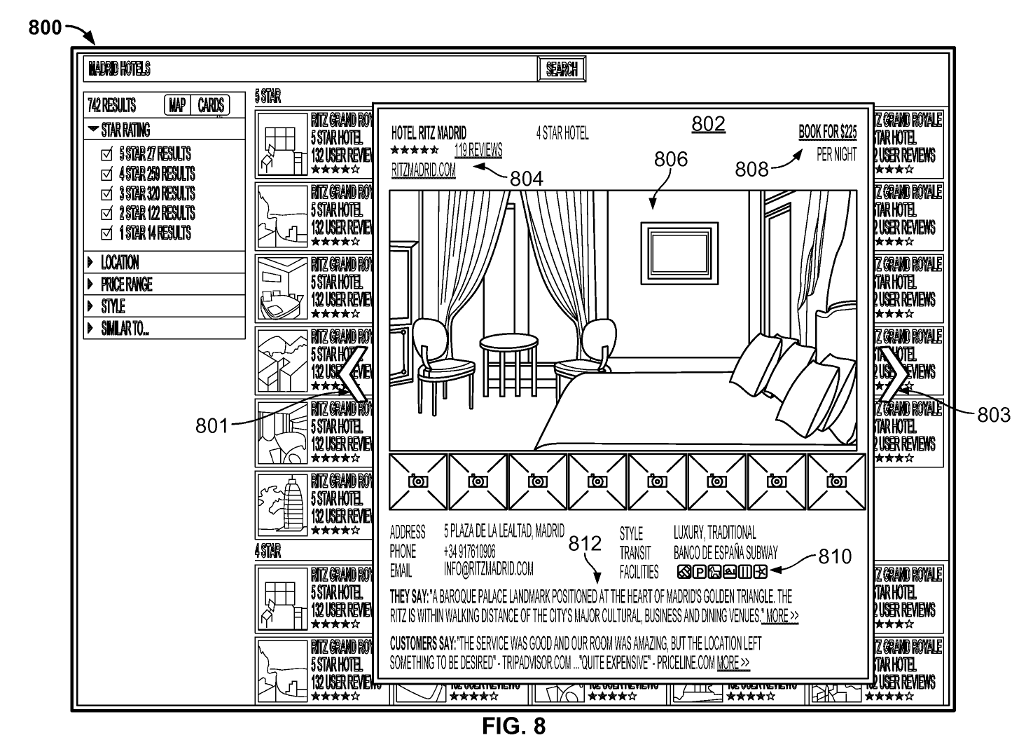

FIG. 8 is an example hotel results interface 800 including a hotel result card 802. The hotel result card 802 is presented as an overlay to a presented listing of hotel results in the hotel results interface 800. In particular, the hotel result card overlay 802 is presented as a using particular scripting that allows a content to be presented as an overlay in response to user selection of a particular hotel result. The particular scripting can allow a user to view additional content without having to leave a current interface, e.g., without leaving a current web page. As shown in the hotel results interface 800, presenting the overlay includes a semi-transparent portion boarder to the hotel result card 802. The use of the dark background for the boarder, which dims the page over which the hotel result card 802 has been overlaid, can also disable the visible portions of the hotel results interface 800.

The hotel result card overlay 802 provides information about the particular selected hotel as well as navigation elements allowing the user to directly go to a corresponding hotel result card for a preceding or subsequent hotel result in a listing of hotel search results. For example, the navigation elements can include back arrow 801 and forward arrow 803. When a particular navigation element is selected by a user, the next sequential hotel card in the indicated direction is presented in the overlay. For example, if a user selects a fifth hotel listing in a listing of hotel results (e.g., the listing of hotel results displayed beneath the overlay), the corresponding hotel result card is presented. Selecting the back arrow results in presentation of the hotel result card for the fourth hotel listing in the listing of hotel results. Selecting the forward arrow results in presentation of the hotel result card for the sixth hotel listing in the listing of hotel results. An animation can be applied such that the hotel cards appear to move to the left or right while being replaced by another hotel result card in response to the user interaction with the navigation elements.

The hotel result card overlay 802 includes hotel information 804, hotel images 806, pricing 808, reviews 812, and other hotel information 810. The hotel information 804 includes the hotel name and contact information (e.g., address, phone number, web site) as well as an indication of hotel class, and average rating by users, and the number of user reviews.

The hotel images 806 include one or more images of the hotel. In particular, one image is depicted along with smaller images, e.g., thumbnails or other reduced/scaled representations. The user can select each smaller image in order to display a larger version of the image.

The pricing 808 indicates the price per night of the hotel for specific dates (e.g., as identified when initiating the search for hotel results). The reviews 812 display portions of reviews, which can each be expanded or retrieved in response to user input. The reviews can include individual reviews as well as professional reviews. Additionally, the reviews can include content provided by the hotel. The source of each review can be indicated. The other hotel information 810 includes other details about the hotel, for example, particular amenities available at the hotel and category information about the hotel as well as additional contact information.

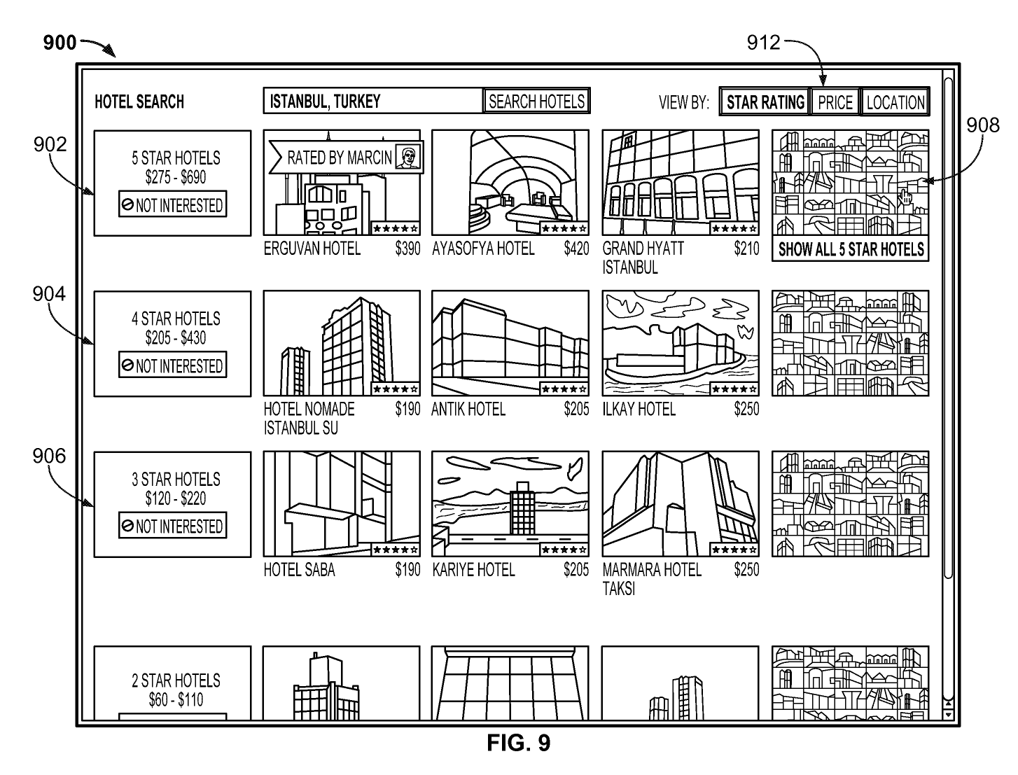

FIG. 9 is an example hotel results interface 900 including a results array ordered by rating class. In particular, hotel results are grouped according to hotel rating class, e.g., a star rating. As shown in FIG. 9, each group is assigned one or more rows in the array. Thus, a first row 902 shows five star hotel results, a second row 904 shows four star hotel results, a third row 906 shows three star hotel results, and so on. Each row includes multiple hotel results belonging to the associated hotel rating class. Additionally, a final entry 908 in the row provides an option to view additional hotel results of that class, e.g., “show all five star hotels.” The final entry 908 also includes a small array showing representations of at least some of the additional hotel results in that class. In some implementations, the additional hotel results are presented inline such that the results of lower class ratings are shifted downward in the hotel results interface.

The first entry in each row can provide information about the hotel results within the row. For example, they can indicate the ratings class as well as a price range for hotels having that ratings class. The first entry can also allow a user to filter the results, for example, by eliminating a particular ratings class of hotels from the results array 900. For example, the first entry can include an interface element allowing a user to indicate that the hotel results of that ratings class should be removed, e.g., because the user is not interested in hotels of that ratings class.

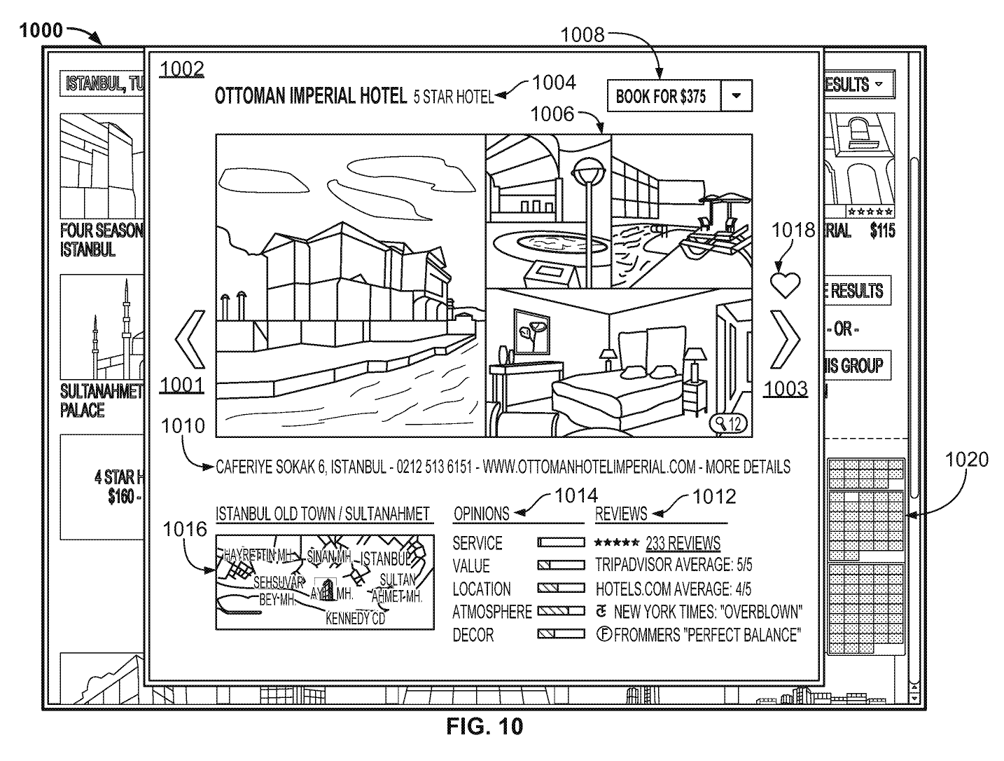

FIG. 10 is an example hotel results interface 1000 including a hotel result card overlay 1002. The hotel result card overlay 1002 is an overlay to a presented array listing of hotel results in the hotel results interface 1000.

The hotel result card overlay 1002 provides information about the particular selected hotel as well as navigation elements allowing the user to directly go to a corresponding hotel result card for a preceding or subsequent hotel result in a listing of hotel search results. For example, the navigation elements can include a back arrow 1001 and a forward arrow 1003. When a particular navigation element is selected by a user, the next sequential hotel card in the indicated direction is presented.

The hotel result card overlay 1002 includes hotel information 1004, hotel images 1006, pricing 1008, reviews 1012, map 1016, opinions 1014, and other hotel information 1010. The other hotel information 1004 includes the hotel name and an indication of hotel class.

The hotel images 1006 include one or more images of the hotel arranged relative to each other in a collage. The pricing 1008 indicates the price per night of the hotel for specific dates (e.g., as identified when initiating the search for hotel results). Additionally, the pricing can include a dropdown menu that displays pricing information for multiple booking options, for example, one or more third party sites and/or the hotel directly.

The reviews 1012 display an average review score as well as a total number of individual reviews. In some implementations, the user can select the number of reviews in order to be presented with an interface including one or more full reviews. Additionally, the reviews 1012 can include review scores for one or more travel sites as well as text from one or more reviewers. The source of each review can be indicated. The opinions 1014 provide indicators for various categories associated with the hotel indicating how the reviewers rate each category. In particular, the opinions 1014 include a bar graph for each respective category. The categories include “service,” “value,” “location,” “atmosphere,” and “decor.”

The other hotel information 1010 includes other details about the hotel, for example, particular amenities available at the hotel and contact information (e.g., address, phone number, web site). Additionally, the map 1016 shows the location of the hotel within a specific geographic region.

An indicator 1018 e.g., a shortlist or favorites allows a user to select individual hotels from the individual hotel card, for example, for later viewing or comparison. The indicator can be highlighted, colored, or otherwise visually distinguished when selected. In other implementations, the indicator allows the user to add the hotel to a shortlist as described above.

A results overview 1020 provides a graphical overview of the array of hotel search results. In particular, the results overview 1020 shows groups of individual elements (e.g., rectangles), each representing hotel search results as grouped by class rating. The hotel result corresponding to the hotel card overlay 1002 is shown as highlighted in the results overview 1020. If the user navigates to a different hotel car, e.g., using the back arrow 1001 or the forward arrow 1003, the results overview 1020 can be updated to highlight the appropriate hotel result represented by the results overview 1020.

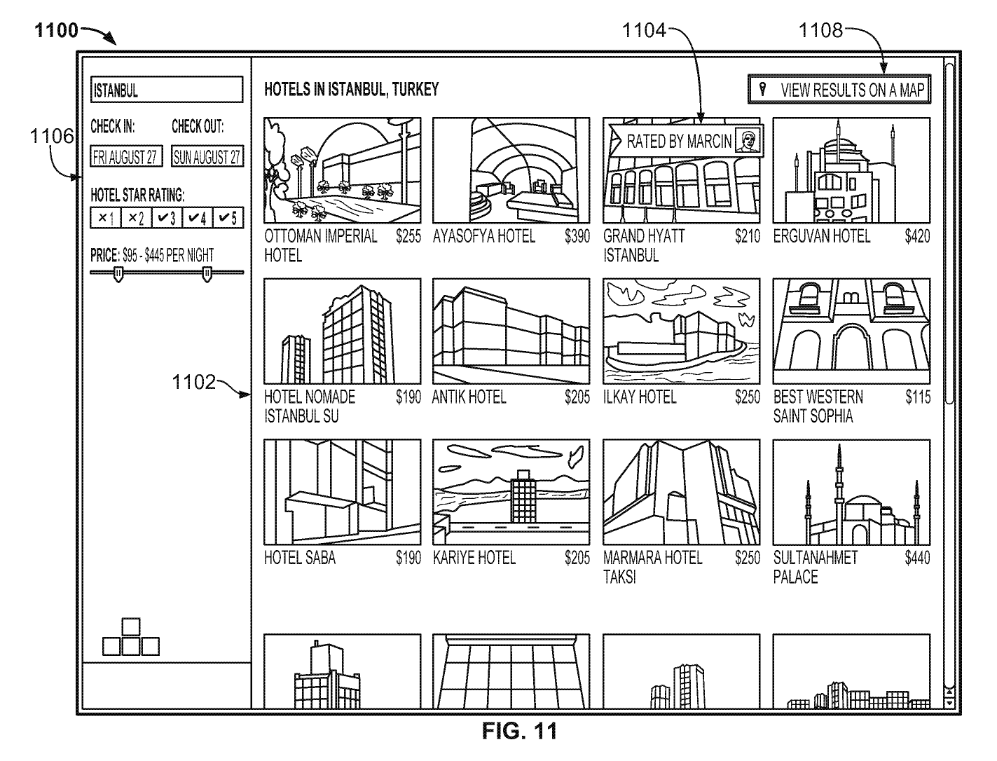

FIG. 11 is an example hotel results interface 1100 including a results array 1102. The hotel results interface 1100 also includes filtering options 1106 and view option 1108. The filtering options 1106 allow a user to modify the presented hotel results, for example, by specifying a hotel star rating or ratings as well as a price range for presented hotel results. The view option 1108 allows a user to instead view the hotel results in the results array 1102 on a map display.

The results array 1102 displays hotel results as an array where each entry is represented by an image of the hotel, the hotel name, and a price for the hotel (e.g., a per night room rate). The hotels in the hotel array 1104 can be ordered according to various criteria, for example, by price, hotel rating, distance from a specified point, or other ranking metric.

One or more hotel entries in the hotel array 1104 can include overlay information. In particular, when other users connected to the user (e.g., as belonging to a same social group or social network) have reviewed or rated a particular hotel, an overlay, e.g., overlay 1104, may be presented to indicate that. Thus, the user can view hotels that have been rated by people they are connected with, to which the user may attach more weight. In some implementations, users opt-in to making their reviews or ratings available to other users including those in their social group.

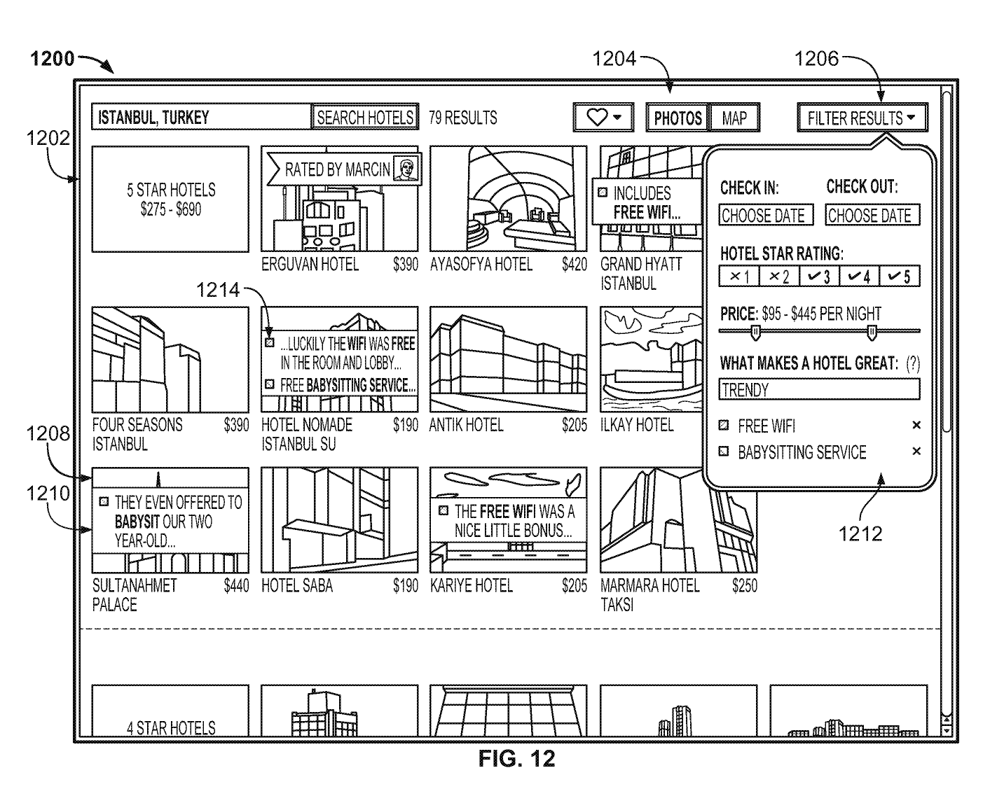

FIG. 12 is an example hotel results interface 1200 including review text. The hotel results interface 1200 includes a results array 1202 and an options bar 1204. The options bar 1204 includes user options to show shortlisted hotels or add particular hotels to a shortlist, to display the hotel results as the results array 1202 or relative to a map, or to filter hotel results.

Filtering options 1206 include filtering by hotel rating and price. Additionally, the filtering options 1206 provides a text field for receiving user input of a particular phrase having one or more words. In particular, a user can enter text describing a quality of feature of a hotel. Each entered phrase can be used to search hotel reviews for associated text, for example, matching one or more terms in the phrase, matching stems of one or more terms in the phrase, or matching synonyms of one or more terms in the phrase. A user can enter more than one distinct phrase. Phrases 1212 show two previously entered phrases “free wifi” and “babysitting service.” Additionally, the user has entered “trendy” in the text field, which, if entered, will be added to phrases 1212. The phrases are color coded so that reviews including the respective phrases 1212 can be differentiated in the results.

For hotel results having reviews that include one or more terms of one or more of the phrases 1212, a representative text segment (e.g., a snippet) can be presented as an overlay over the hotel result in the results array 1202. For example, hotel results 1208 includes a text overlay 1210 that is associated with the phrase “babysitting service”. If more than one phrase has an associated review, a respective text portion can be displayed for each matching phrase, as shown in overlay 1214. The respective text portions are displayed in the overlay along with the assigned color code so that the user can identify which phrase the text portion is associated with.

In some implementations, reviews are identified from one or more review sources (e.g., particular web sites). These reviews are searched, for example, based on the user entered phrase, over the hotel results. In some implementations, review text portions can be ranked by a search system in order to determine which text portion to present for a given hotel, and, in some other implementations, to reorder the hotel results in the results array. In some implementations, particular themes that commonly occur in reviews can be prepopulated (e.g., “pool”, “rooftop bar”) such that these themes are presented in the filtering options.

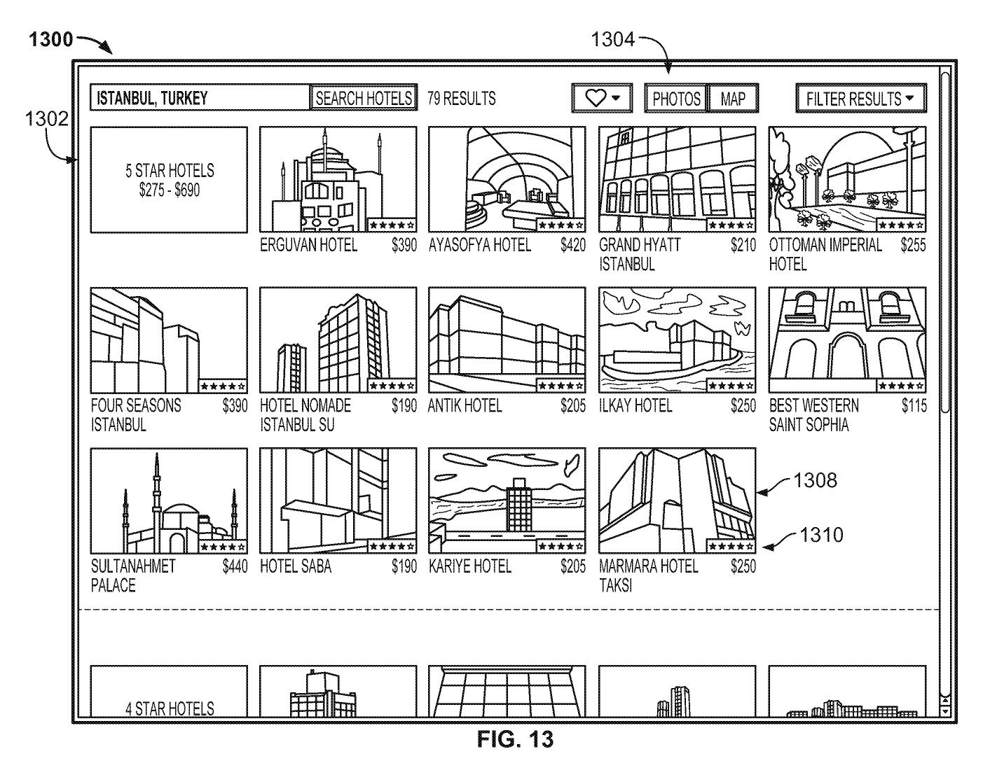

FIG. 13 is an example hotel results interface 1300 including rating class. The hotel results interface 1300 includes a results array 1302 and an options bar 1304. The options bar 1304 includes user options to show shortlisted hotels or add particular hotels to a shortlist, to display the hotel results as the results array 1302 or relative to a map, or to filter hotel results.

The results array 1302 displays hotel results as an array where each entry is represented by an image of the hotel, the hotel name, and a price for the hotel (e.g., a per night room rate). The hotels in the results array 1302 can be ordered according to various criteria, for example, by price, hotel rating, distance from a specified point, or other ranking metric. Each result in the results array 1302 includes an overlay of the corresponding star rating assigned to the respective hotel. For example, results array 1302 includes hotel result 1308. Hotel result 1308 includes a rating overlay 1310. Thus, the user can quickly view ratings for each hotel within the hotel array. In some other implementations, the hotel rating is an average reviewer rating. In some implementations, the results are ordered according to hotel rating. Alternatively, the hotel results can be grouped according to rating and then ordered according to other criteria, for example, price or average reviewer rating.

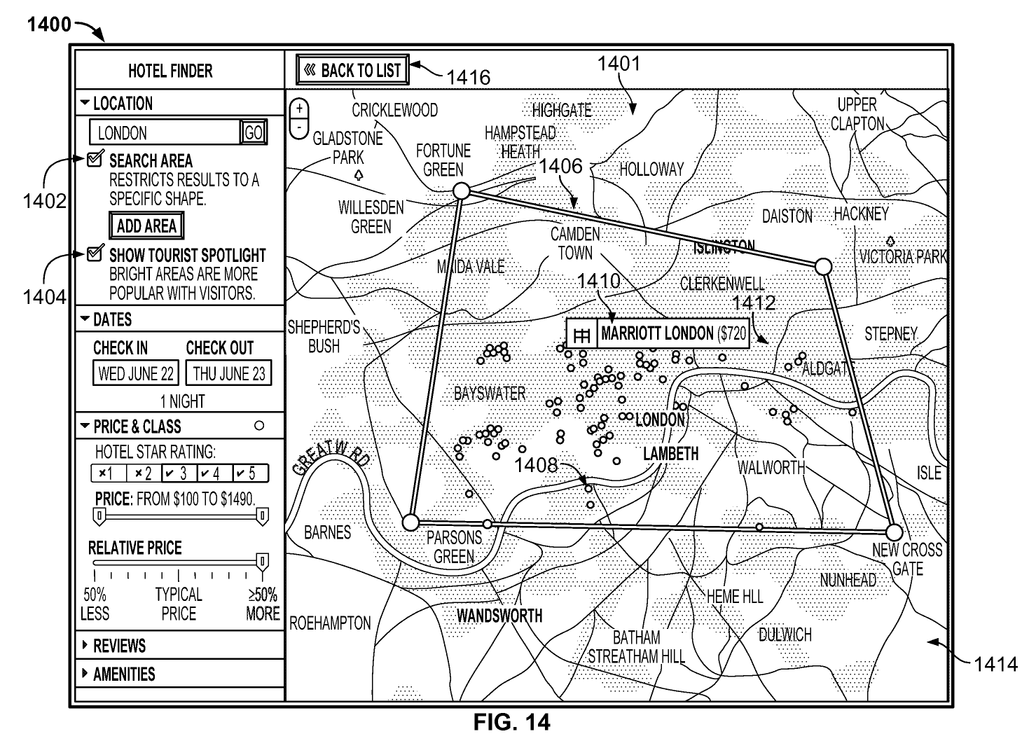

FIG. 14 is an example hotel results map interface 1400 including a tourist spotlight. The hotel results map interface 1400 includes a map 1401 displaying a particular geographic region. The hotel results map interface 1400 can be presented in response to a user input, for example, from a listing of hotel results, requesting a map display. The hotel results map interface 1400 also includes a location portion in which the current location shown in the map is displayed and one or more filters for modifying the search parameters.

The map 1401 can be an interactive map in which the user can modify a zoom level. Additionally, map 1401 includes a polygon 1406 that defines a region to which hotel results are limited. In some implementations, the results are limited to the geographic area bounded by the polygon in response to a user selection, e.g., of checkbox 1402 indicating that results are restricted to the particular shape.

The polygon 1406 can be an overlay to the map 1401 defined according to particular criteria identifying a region for which hotel results are to be displayed. For example, the polygon 1406 can be determined based on evaluation of a geographic density of points of interest. In some implementations, the dimensions of the polygon 1406 can be modified by the user. For example, the user can select and drag a vertex of the polygon 1406 to a different location on the map 1401 in order to resize the polygon 1406. The displayed hotel indicators can be updated based on the updated dimensions of the polygon 1406. In some implementations, additional polygons can be displayed concurrently. For example, additional polygons can be added that indicate other areas of interest, for example, a polygon can be added to indicate a second most popular area for tourists after the first polygon.

Each hotel result is indicated by an indicator 1408 (e.g., a blue dot). Selection or hovering over of a particular indicator results in a hotel label 1410 displaying the name of the hotel corresponding to the indicator and other optional information, for example, a price and an image of the hotel. In some implementations, a selection provides additional details about the hotel, for example, in a details overlay or separate details interface.

Additionally, the map 1401 includes a spotlighting feature that indicates areas identified as appealing to tourists. For example, a gradient can be applied that attributes lighter areas 1412 to areas with a high association to tourists or tourist activities and darker areas 1414 that have a low association with tourists or tourist activities. In some implementations, the spotlighting feature can be toggled on or off based on a user input, e.g., to checkbox 1404. In some other implementations, the gradient can indicate other characteristics. For example, instead of areas appealing to tourists, the gradient can be associated with an association to business or sports. The user can return to an interface showing hotel results as a list rather than a map using element 1416.

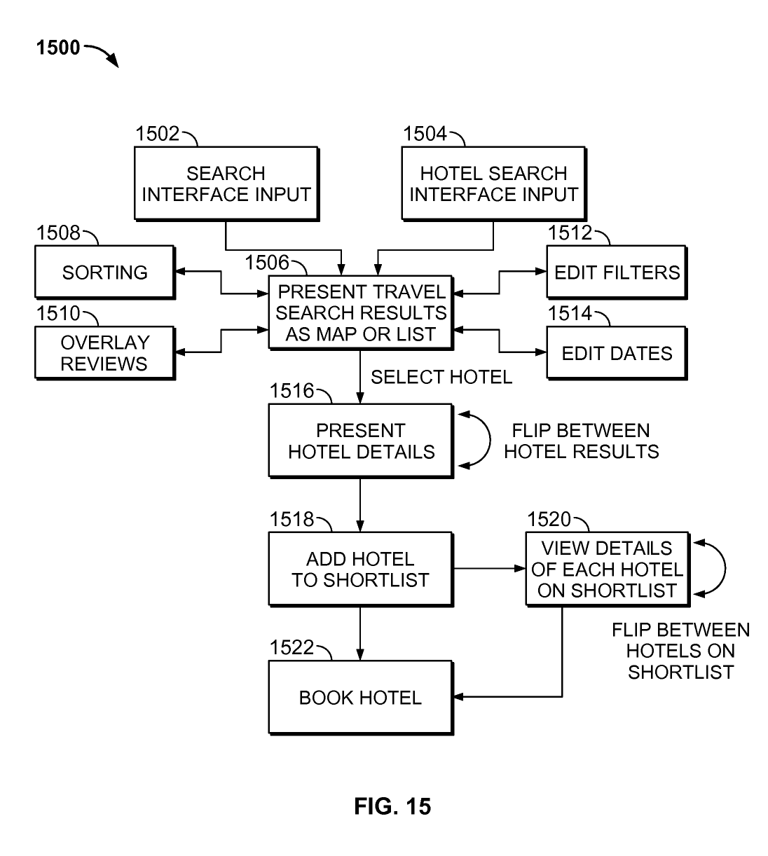

FIG. 15 is a flow diagram of an example process 1500 for presenting hotel search results. For convenience, the process 1500 will be described with respect to a system including one or more computing devices that performs the process 1500. The system receives an input from either a general search interface 1502 or a hotel search interface 1504. The system presents travel search results in response to the input as a map or list of results 1506. One or more inputs are received from a user interacting with the presented travel search results. In response to the input, the system can sort results 1508. The sorting can be according to different criteria, for example, relative price, as described above. The system can also modify presented search results based on user edits to filters 1512 or user edits to the dates of travel 1514. Additionally, the system can display an overlay of reviews on the presented search results 1510.

In response to a user selecting a hotel, the system presents hotel details 1516. The hotel details can be presented in a separate interface or as part of an overlay to the results. The hotel details provide additional information about the selected hotel including photos, reviews, and other information, for example, as described in detail above. The user can flip between hotel details for different hotels in the hotel results directly from the presented hotel details, for example, using arrow buttons that allow the user to navigate through the hotels results forward or backward.

In response to a user request, particular hotels can be added to a shortlist 1518. For example, the hotel details can include an interface element that, when selected, adds the hotel to the shortlist. The user can then request to view the details for each hotel on the shortlist, for example, in order to compare the hotels. If requested, the system presents the details of the shortlist hotels 1520. The user can flip between the hotel details for each hotel on the shortlist. The system receives a request to book a particular hotel 1522. In response, the user can be directed to a particular third party booking location, for example, a particular web page. In some implementations, the user is presented with two or more third party booking locations for selection. For example, each can be presented with a corresponding price for the hotel.

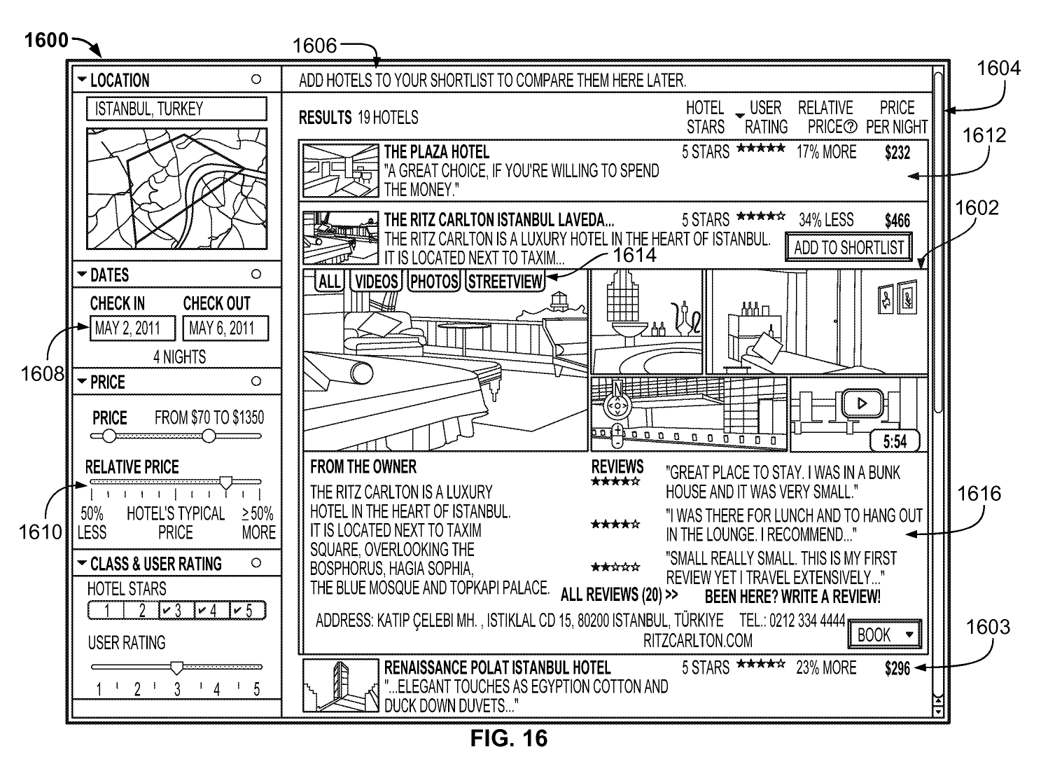

FIG. 16 is an example hotel results interface 1600 including an expanded hotel result 1602. The hotel results interface 1600 includes a first region 1604 displaying a listing of hotel results 1603, a second region 1606 for displaying a hotel shortlist, dates 1608, and filtering parameters 1610.

The listing of hotel results 1603 includes a number of separate listings for hotels responsive to a search. Additionally, one of the listings is the expanded hotel result 1602. The expanded hotel result 1602 can be, for example, the result of a user input to, or selection of, a hotel in the listing of hotel results 1603. For example, selection of hotel 212 of FIG. 2. The expanded hotel result 1602 provides additional information about the particular hotel compared with a non-expanded listing, for example, hotel listing 1612.

In particular, the expanded hotel result 1602 includes tabs 1614. The tabs 1614 indicate different modes, each mode presenting different types of information to be selectively displayed in the expanded hotel result 1602. Specifically, the tabs 1644 include “all” indicating a summary mode, “videos” mode, “photos” mode, and “streetview” mode. In some implementations, other modes can be presented with separate tabs, for example, a reviews mode or a panoramas mode. Additionally, in some implementations, the photos mode can be restricted to particular types of photos, for example, lobby photos or pool photos. For example, the expanded hotel result can include multiple photo tabs for different photo modes or a submenu of different photo modes under a single photo tab (e.g., photos/pool).

The expanded hotel result 1602 includes content based on the summary mode provided by the “all” tab. In some implementations, the summary mode provided by the “all” tab is a default mode when expanding a hotel search result listing. Alternatively, the user can select the particular tab to initiate the summary mode. In particular, the expanded listing includes a display of an array of content including images of the hotel, a video, and a map streetview scene (e.g., an image from a mapping application that displays an image associated with an address or location as taken from a street). In some implementations, the displayed video can be played from within the expanded hotel result 1602. In some other implementations, the view of the streetview scene can be manipulated (e.g., a user can pan or zoom) from within the expanded hotel result 1602. In some implementations, a user enters other modes by selecting corresponding content in the array of content presented in the summary mode. For example, the user can select the video image in order to switch to the videos mode.

The expanded hotel result 1602 also includes additional information 1616. The additional information can include review or review excerpts, a description from the hotel, and a booking option.

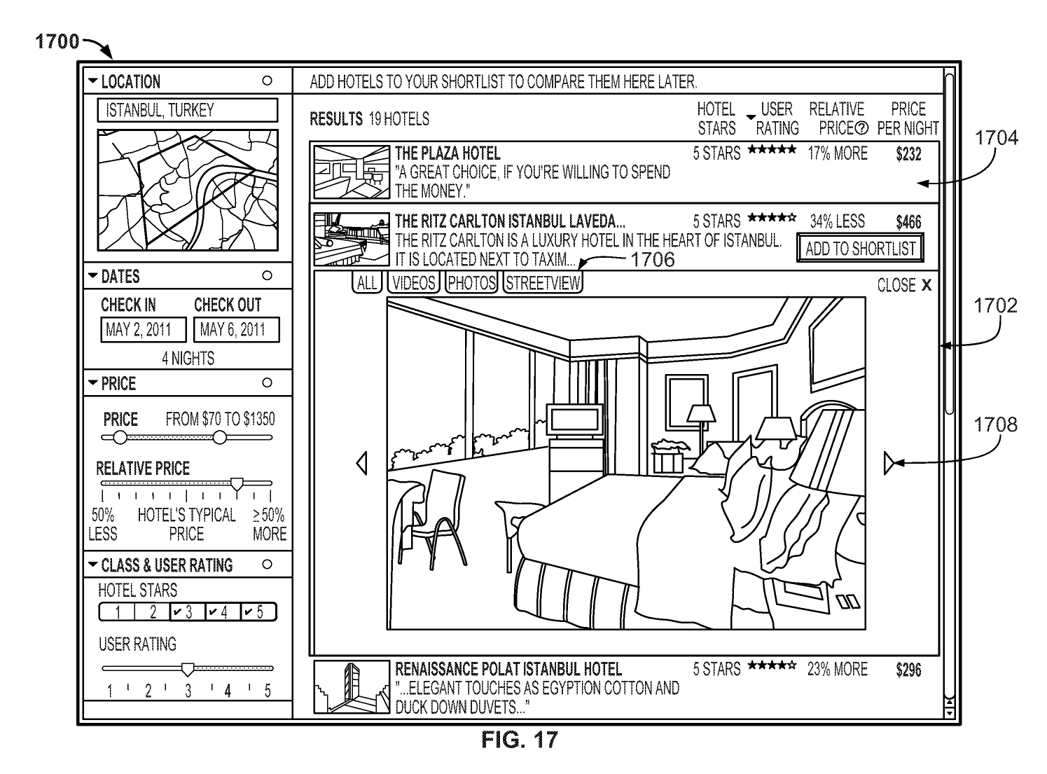

FIG. 17 is an example hotel results interface 1700 including an expanded hotel result 1702 including an image. The hotel results interface 1700 includes a listing of hotel results 1704. The listing of hotel results 1704 includes a number of separate listings for hotels responsive to a search. Additionally, one of the listings is the expanded hotel result 1702. The expanded hotel result 1702 can be, for example, the result of a user input to, or selection of, a hotel in the listing of hotel results 1704. The expanded hotel result 1702 provides additional information about the particular hotel compared with other non-expanded listings of the listing of hotel results 1704.

The expanded hotel result 1702 includes tabs 1706. The tabs 1706 indicate different modes, each mode presenting different types of information to be selectively displayed in the expanded hotel result 1702. Specifically, the tabs 1706 include “all,” “videos,” “photos,” and “streetview.” The expanded hotel result 1702 includes content based on the “photos” mode.

In particular, the expanded hotel result 1702 includes a large image associated with the hotel. Additionally, navigation elements (e.g., right arrow 1708) allow the user to view additional images associated with the hotel from within the expanded hotel result 1702, for example, in the form of a slideshow within the expanded hotel result 1702. In particular, using the navigation elements, the user can move forward or backward through a set of images provided for the hotel result.

In some implementations, the user can further navigate similar images from other search results, e.g., using the navigation elements. In some implementations, the images are restricted to particular types of images for the particular mode, for example, a photos/pool mode that displays pool images. The user can use the navigation elements (e.g., right arrow 1708) to view a corresponding pool image for each hotel in the listing of hotel results.

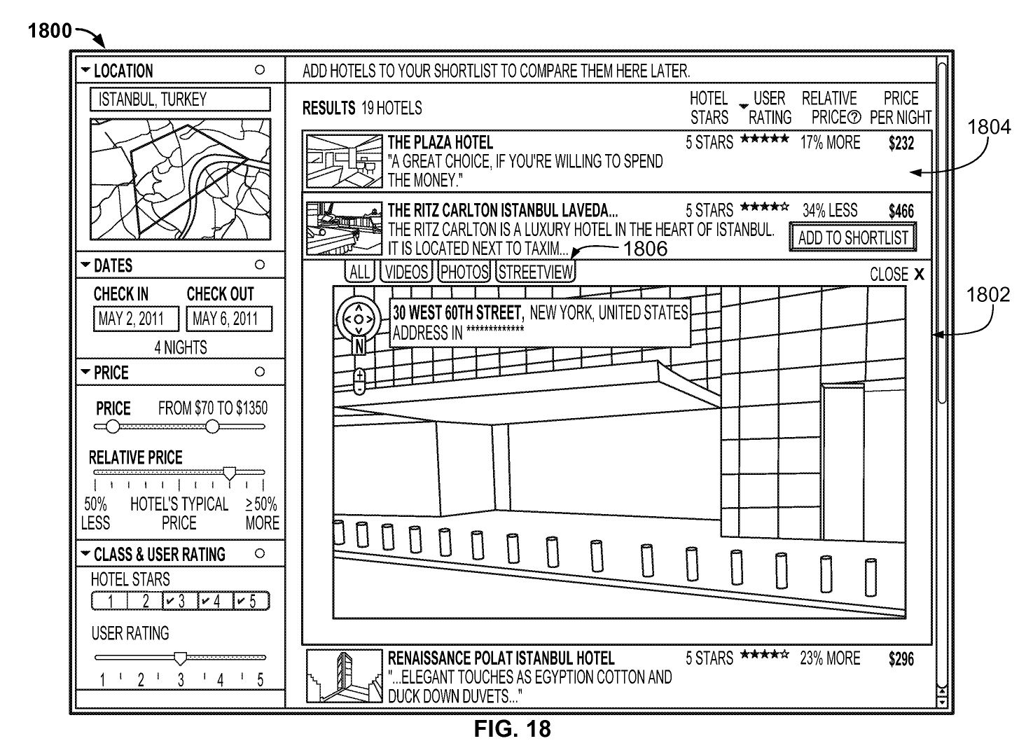

FIG. 18 is an example hotel results interface 1800 including an expanded hotel result 1802 including a street view. The hotel results interface 1800 includes a listing of hotel results 1804. The listing of hotel results 1804 includes a number of separate listings for hotels responsive to a search. Additionally, one of the listings is the expanded hotel result 1802. The expanded hotel result 1802 can be, for example, the result of a user input to, or selection of, a hotel in the listing of hotel results 1804. The expanded hotel result 1802 provides additional information about the particular hotel compared with other non-expanded listings of the listing of hotel results 1804.

The expanded hotel result 1802 includes tabs 1806. The tabs 1806 indicate different modes, each mode presenting different types of information to be selectively displayed in the expanded hotel result 1802. Specifically, the tabs 1806 include “all,” “videos,” “photos,” and “streetview.” The expanded hotel result 1802 includes content based on the “streetview” mode.

In particular, the expanded hotel result 1802 includes a large streetview scene associated with the hotel. The streetview scene shows an image representing a view of the hotel from the street near the hotel. For example, the image can be obtained by a vehicle moving along the street capturing images. In some implementations, the vehicle captures images in multiple directions. In some implementations, the streetview scene is a static image.

In some other implementations, the user can manipulate the streetview scene within the expanded hotel result 1802. For example, the user can zoom into a portion of the displayed image. In another example, the streetview scene provides an environment in which the user can pan to the sides or up and down by a specified number of degrees of rotation (e.g., dependent upon the range of images used when generating the streetview scene).

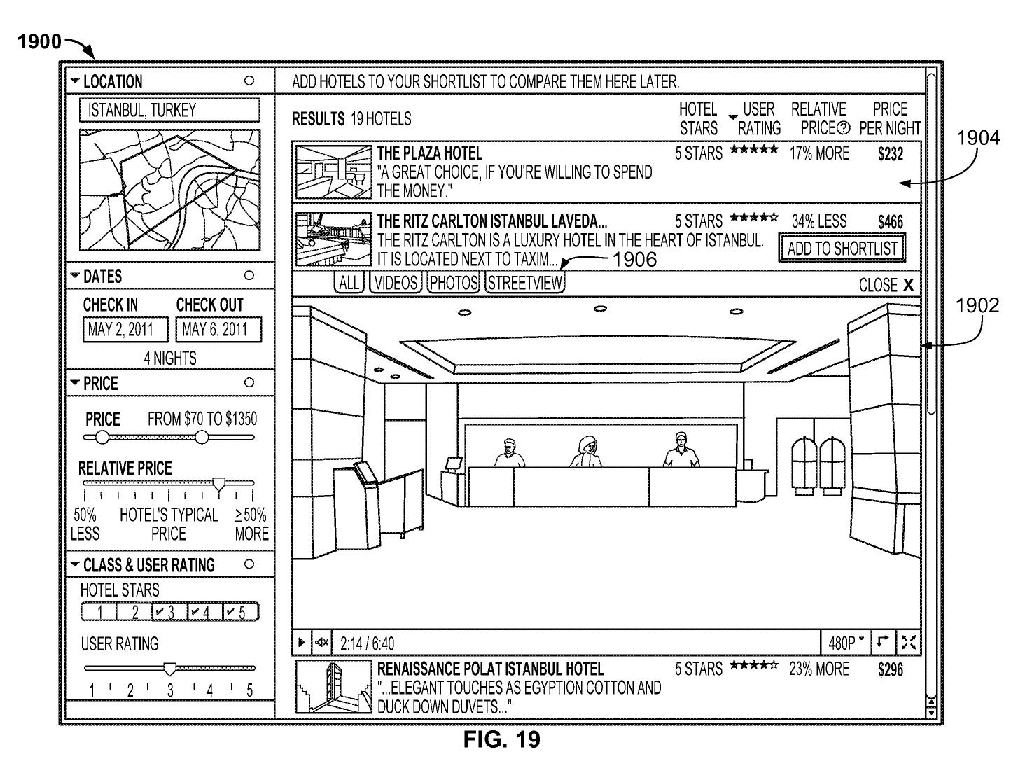

FIG. 19 is an example hotel results interface 1900 including an expanded hotel result 1902 including a video. The hotel results interface 1900 includes a listing of hotel results 1904. The listing of hotel results 1904 includes a number of separate listings for hotels responsive to a search. Additionally, one of the listings is the expanded hotel result 1902. The expanded hotel result 1902 can be, for example, the result of a user input to, or selection of, a hotel in the listing of hotel results 1904. The expanded hotel result 1902 provides additional information about the particular hotel compared with other non-expanded listings of the listing of hotel results 1904.

The expanded hotel result 1902 includes tabs 1906. The tabs 1906 indicate different modes, each mode presenting different types of information to be selectively displayed in the expanded hotel result 1902. Specifically, the tabs 1906 include “all,” “videos,” “photos,” and “streetview.”

In particular, the expanded hotel result 1902 shows the videos mode that includes a video associated with the hotel. The video can be played directly within the expanded hotel result 1902. The video includes controls for playback and volume. In some implementations, the user can expand the video to full screen. In some implementations, selecting the video causes a new interface to be presented including the video for playback, or directs the user to a different location including the video for playback (e.g., on the hotel's web site).

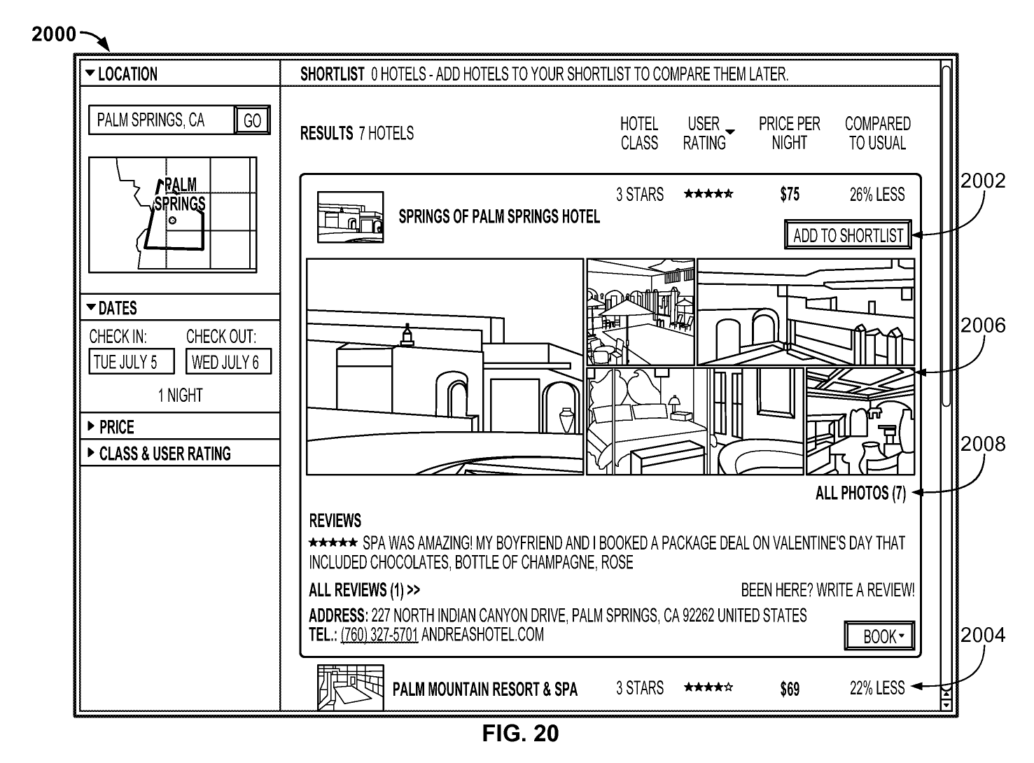

FIG. 20 is an example hotel results interface 2000 including an expanded hotel result 2002. The hotel results interface 2000 includes a listing of hotel results 2004. The listing of hotel results 2004 includes a number of separate listings for hotels responsive to a search. Additionally, one of the listings is the expanded hotel result 2002. The expanded hotel result 2002 can be, for example, the result of a user input to, or selection of, a hotel in the listing of hotel results 2004. The expanded hotel result 2002 provides additional information about the particular hotel compared with other non-expanded listings of the listing of hotel results 2004.

The expanded hotel result 2002 presents information about the hotel result including a collection of images 2006. The images of the collection of images 2006 can be arranged according to a particular template where different images have different sizes and are selected for particular location according to specified criteria. The expanded hotel result 2002 also includes a control element 2008 (e.g., selectable text) for displaying additional images for the hotel.

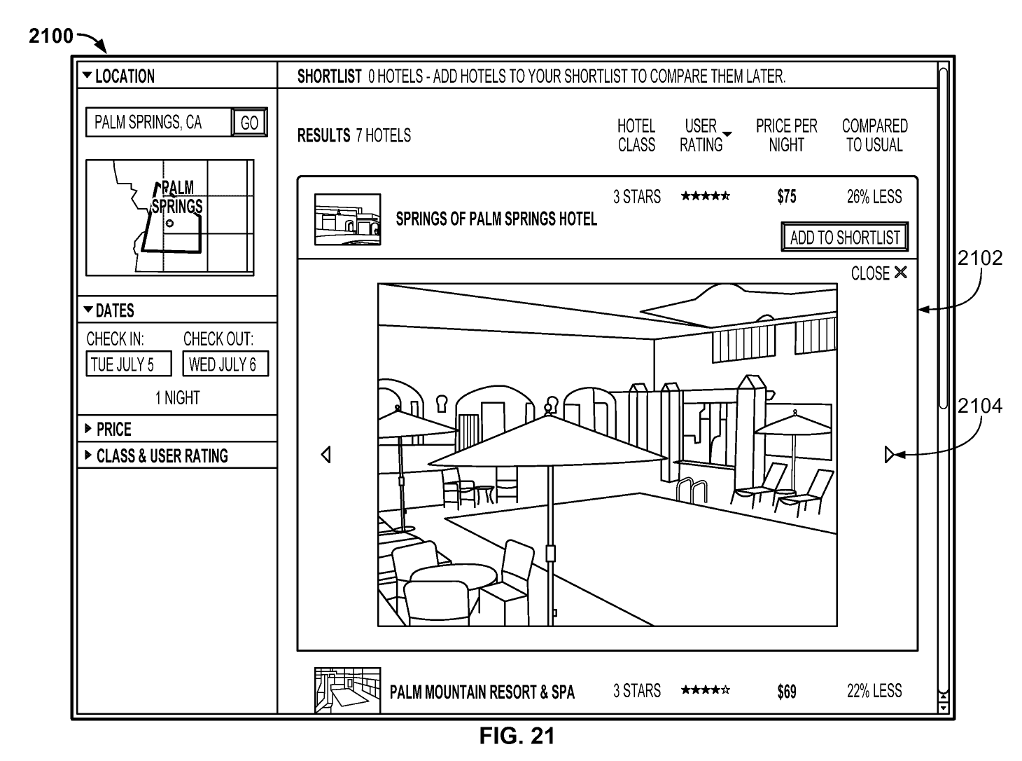

FIG. 21 is an example hotel results interface 2100 including an expanded hotel result 2102. The hotel results interface 2100 includes a listing of hotel results 2104. The listing of hotel results 2104 includes a number of separate listings for hotels responsive to a search. Additionally, one of the listings is the expanded hotel result 2102.

The expanded hotel result 2102 presents a large image along with navigation elements, e.g., navigation arrow 2104. The navigation elements allow the user to view additional images associated with the hotel from within the expanded hotel result 2102, for example, in the form of a slideshow within the expanded hotel result 2102. In particular, using the navigation elements, the user can move forward or backward through a set of images provided for the hotel result. In some implementations, the large individual image in the expanded hotel result 2102 is presented in response to the user selection of the control element 2008 of the hotel results interface 2000 requesting additional images. Alternatively, in some implementations, the user navigates through similar images across hotels in the listing of hotel results 2104, e.g., an image of a lobby or pool for each hotel.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving an input specifying one or more hotel search parameters;
obtaining hotel search results responsive to the input;
presenting the hotel search results in a first region of a hotel search results interface having at least two regions, wherein the at least two regions are distinct from each other, and are simultaneously present and nonoverlapping;
receiving a user selected hotel from among the hotel search results; and
presenting information about the user selected hotel in a second region of the hotel search results interface.

2. The method of claim 1, wherein each of the one or more hotel listings includes an indicator of the relative price of a particular hotel compared to historic prices for that hotel.

3. The method of claim 1, further comprising presenting one or more filters in a third region of the hotel search results interface.

4. The method of claim 1, further comprising:
receiving a user input selecting a hotel from the one or more hotel listings; and
expanding an entry for the selected hotel inline within the one or more hotel listings, wherein the expanded entry displays additional information about the selected hotel.

5. The method of claim 1, further comprising:
receiving an input selecting a hotel listing from the plurality of hotel listings; and
presenting a hotel card displaying additional hotel information, wherein the hotel card includes one or more of photos, reviews, pricing, or purchasing options for the hotel.

6. A method performed by data processing apparatus, the method comprising:
receiving an input specifying one or more hotel search parameters;
receiving hotel search results responsive to the input; and
presenting the hotel search results in a plurality of groups in a hotel search results interface, wherein each group is associated with a group criteria and includes one or more of the hotel search results that satisfies the group criteria.

7. The method of claim 6, wherein the group criteria for at least one of the plurality of groups is a rating level for the hotels in the group.

8. The method of claim 6, further comprising: displaying a hotel card in response to a user selection of a particular hotel listing of the plurality of hotel listings.

9. A method performed by data processing apparatus, the method comprising:
receiving an input specifying one or more hotel search parameters;
receiving hotel search results responsive to the input;
presenting the hotel search results in a first region of a hotel search results interface that includes at least two regions, wherein the at least two regions are distinct from each other, and are simultaneously present and nonoverlapping; and
presenting a map of the hotel search results in a second region of the hotel search results interface, wherein the location of each hotel search result is displayed as an icon on the map.

10. The method of claim 9, further comprising displaying a gradient overlay to the map such that particular geographic areas identified as having a particular characteristic are displayed brighter than other geographic areas of the map.

11. A system comprising:
one or more memory devices for storing instructions;
one or more processors for executing the instructions stored in the one or more memory devices in order to:
receive an input specifying one or more hotel search parameters;
obtain hotel search results responsive to the input; and
present the hotel search results in a first region of a hotel search results interface that includes at least two regions, wherein the at least two regions are distinct from each other, and are simultaneously present and nonoverlapping;
receive a user selected hotel from among the hotel search results; and
present the user selected hotel in a second region of the hotel search results interface.

12. The system of claim 11, wherein each of the one or more hotel listings includes an indicator of the relative price of a particular hotel compared to historic prices for that hotel.

13. The system of claim 11, wherein the one or more processors further execute instructions to present one or more filters in a third region of the hotel search results interface.

14. The system of claim 11, wherein the one or more processors further execute instructions to:
receive a user input selecting a hotel from the one or more hotel listings; and
expand an entry for the selected hotel inline within the one or more hotel listings, wherein the expanded entry displays additional information about the selected hotel.

15. The system of claim 11, wherein the one or more processors further execute instructions to:
receive an input selecting a hotel from the plurality of hotel listings; and
present a hotel card displaying additional hotel information, wherein the hotel card includes one or more of photos, reviews, pricing, or purchasing options for the hotel.

16. A system comprising:
one or more memory devices for storing instructions;
one or more processors for executing the instructions stored in the one or more memory devices in order to:
receive an input specifying one or more hotel search parameters;
receive hotel search results responsive to the input; and
present the hotel search results in a plurality of groups in a hotel search results interface, wherein each group is associated with a group criteria and includes one or more of the hotel search results that satisfies the group criteria.

17. The system of claim 16, wherein the group criteria for at least one of the plurality of groups is a rating level.

18. The system of claim 16, wherein the one or more processors further execute instructions to: display a hotel card in response to a user selection of a particular hotel listing of the plurality of hotel listings.

19. A system comprising:
one or more memory devices for storing instructions; and
one or more processors for executing the instructions stored in the one or more memory device in order to:
receive an input specifying one or more hotel search parameters;
receive hotel search results responsive to the input;
present the hotel search results in a first region of a hotel search results interface that includes at least two regions, wherein the at least two regions are distinct from each other, and are simultaneously present and nonoverlapping; and
present a map of the hotel search results in a second region of the hotel interface, wherein the location of each hotel search result is displayed as an icon on the map.

20. The system of claim 19, wherein the one or more processors further execute instruction to display a gradient overlay to the map such that particular geographic areas identified as having a particular characteristic are displayed brighter than other geographic areas of the map.
